(19) United States
(12) Patent Application Publication
(10) Pub. No.: US 2008/0286068 A1
(43) Pub. Date: Nov. 20, 2008

(54) Rotary part mounting mechanism

(76) Inventor: Takashi Yamanaka, Tokyo (JP)

Correspondence Address: CLARK & BRODY, 1090 VERMONT AVENUE, NW, SUITE 250, WASHINGTON, DC, 20005, US

(21) Appl. No.: 11/987,023

(22) Filed: Nov. 27, 2007

(30) Foreign Application Priority Data
Nov. 30, 2006 (JP) 2006-322819

(51) Int. Cl. F16B 19/00

(52) U.S. Cl. 411/360

(57) ABSTRACT

The present invention proposes a mounting mechanism where a rotary part can be easily and assuredly mounted to a mounting plate; and the mounting mechanism has a supporting part composed of an annular plate having a circular center hole, and a support cylinder that projects concentrically with the circular center hole on one surface side of the annular plate, and a fixing cylinder that has an inner circumferential surface, which is continuous to the circular center hole on said one surface side of the annular plate, and that projects along the axis line direction to be longer than the support cylinder; the fixing cylinder has a tapered surface whose diameter becomes smaller toward the end on the inner circumference, which is situated further compared to the end of the support cylinder and is divided into three or more along the circumferential direction; the support cylinder is fitted into the circular hole of the rotary part; the fixing cylinder of the supporting part is fitted into the circular fixing hole of the mounting plate; a securing part is fitted into the fixing cylinder and the tapered surface is pressed by its end; and the end of the fixing cylinder is warped outward due to elastic deformation.

### BACKGROUND OF THE INVENTION

1. Field of the Invention

The present invention relates to a rotary part mounting mechanism where a rotary part can be easily and solidly rotatably mounted to a mounting plate.

2. Description of the Prior Art

In Japanese Laid-open Patent Application Publication No. 63-163011, a binder that superimposes and binds two plates A and B is described, which is composed of a main constituent (1) and a pin member (2), wherein the main constituent (1) is equipped with a square flange (3), two legs (5, 5) hanging from the lower surface of the flange, and an engaging projection (9) facing the internal surfaces of the legs. At the same time, the pin member (2) is provided with a prismatic spindle (6) and a head (7) arranged at the upper end of the spindle, designed so that after two plates A and B are superimposed in a state where their square holes are aligned and the main constituent (1) is inserted into both of the square holes, the pin member (2) is pressed and inserted between the legs (5, 5) of the main constituent (1) from the flange (3) side. If pressed until both of the upper surface of the head of the pin member (2) and the upper surface of the flange become the same height, the spindle (6) presses the engaging projection (9) and both of the legs (5, 5) are pushed outward becoming wider, binding the two plates A and B.

Japanese Laid-open Patent Application Publication No. 2-62412 describes a combining device that binds two panels (16, 18) at an interval, wherein the combining device is composed of a hollow body (12) and a pin (14), with the pin (14) being insertable into the hollow body (12). The design is such that when the pin (14) is completely inserted into the hollow body (12), if a large diameter part (38) of the pin (14) is inserted into a large diameter hole (30) of the hollow body (12), the internal movement of an elastic wing (42) of the hollow body (12) is prevented and one panel (16) is maintained. Further, the other panel (18) is engaged with an inclined surface (48) where a minor diameter part (40) of the pin (14) is inserted into a small diameter hole (32) and a small diameter shank (26) of the hollow body (12), and as a result, the hollow body (12) expands outward and the other panel (18) is maintained.

However, even though the binder disclosed in Japanese Laid-open Patent Application Publication No. 63-163011 is capable of superimposing and binding two plates, it is not suitable for rotatably mounting a rotary part to a mounting plate.

Even though the combining device disclosed in Japanese Laid-open Patent Application Publication No. 2-62412 is also capable of binding two plates at an interval, it is still not suitable for rotatably mounting a rotary part to a mounting plate.

The present invention has been accomplished by taking these problems into consideration, and an object of the present invention is to provide a rotary part mounting mechanism where a rotary part can be easily and solidly rotatably mounted to a mounting plate, in addition to which the mounted rotary part is smoothly rotatable.

### SUMMARY OF THE INVENTION

The rotary part mounting mechanism relating to the present invention comprises a supporting part that is fitted into a circular hole established at the rotation center of the rotary part and a securing part that secures the supporting part to a circular fixing hole established in the mounting plate.

Said supporting part comprises an annular plate having a circular center hole, a support cylinder that projects concentrically with an axis line of the circular center hole at one surface side of this annular plate, and that projects along the axis line radially outward from the circular center hole, and that concurrently rotatably supports the rotary part, and a fixing cylinder that has an inner circumferential surface, which is continuous to the circular center hole at one surface side of the annular plate, and that concurrently projects along the axis line to be longer than the support cylinder for securing the mounting plate, and in the fixing cylinder, a tapered surface whose diameter becomes smaller toward the end of the fixing cylinder is established at a position that is further extended from the end along the axis line direction of the support cylinder on the inner circumferential surface, wherein the fixing cylinder is divided into three or more units along the circumferential direction by a notch means, and the securing part is composed of a pressing portion that passes through the circular center hole from the other surface side of the annular plate and is inserted into the fixing cylinder and an end plate arranged at the base of the pressing portion.

For the assembly, the support cylinder of the supporting part is fitted into the circular hole of the rotary part, and the fixing cylinder of the supporting part is fitted into the circular fixing hole of the mounting plate, so that said rotary part is rotatably held between the mounting plate and the annular plate of the supporting part. The pressing portion of the securing part is fitted into the fixing cylinder and the tapered surface of the fixing cylinder is pressed by the end of the pressing portion; and the end of the fixing cylinder is warped outward radially due to elastic deformation, resulting in the fixation of the mounting plate to the supporting part preventing it from rotating.

The securing part may have multiple serrated projections that are inclined toward the end plate side from the end side on the outer circumferential surface of the pressing portion.

In the mounting mechanism of the present invention with the configuration mentioned above, after the supporting part is fitted into the circular fixing hole of the mounting plate through the circular hole of the rotary part, if the securing part is fit into the supporting part, the rotary part is easily mounted to the mounting plate.

The support cylinder is fitted into the circular hole of the rotary part and the pressing portion of the securing part is fitted into the fixing cylinder, mounting the rotary part on the mounting plate. Because the support cylinder that smoothly rotates the mounted rotary part and the fixing cylinder that is fixed to the mounting plate are separately arranged, the rotary part can be easily and solidly mounted to the mounting plate while maintaining the rotation state. In addition, the smooth rotation of the rotary part can be sufficiently maintained.

Multiple serrated projections that are inclined toward the end plate side from the end side may be arranged on the outer circumferential surface of the pressing portion of the securing part, these projections function to prevent disengagement, so the securing part can be comparatively easily fitted into the fixing cylinder. However, it becomes difficult for the securing part to detach from the fixing cylinder. Therefore, the rotary part can be further solidly mounted to the mounting plate.

### BRIEF DESCRIPTION OF THE DRAWINGS

The invention will become more apparent upon a reading of the following detailed description with reference to the accompanying drawings.

FIG. 1 is a longitudinal cross-sectional view of the supporting part in the rotary part mounting mechanism along the A-A line in FIG. 2, showing a first embodiment relating to the present invention;

FIG. 2 is a plan view of the supporting part in FIG. 1;

FIG. 3 is a side view of the securing part functioning with the supporting part shown in FIG. 1;

FIG. 4 is a longitudinal cross-sectional view showing the assembly state where the supporting part is fitted into the circular hole of the rotary part;

FIG. 5 is a longitudinal cross-sectional view showing the assembly state further fitting into the circular fixing hole of the mounting plate from the assembly state shown in FIG. 4;

FIG. 6 is a cross sectional view showing the final assembly state where the securing part is further fitted from the assembly state shown in FIG. 5; and

FIG. 7 is a partially enlarged cross-sectional view of the pressing portion of the securing part showing a modified example of the rotary part mounting mechanism relating to the present invention.

### DESCRIPTION OF THE PREFERRED EMBODIMENTS

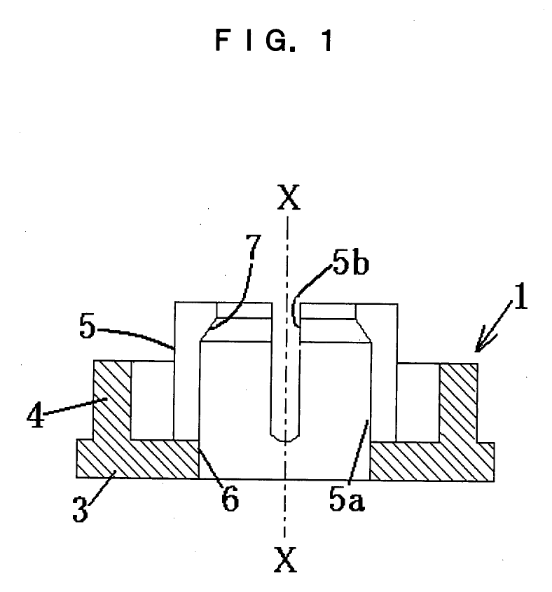

The first embodiment of the present invention is described hereafter, with reference to FIG. 1 to FIG. 6.

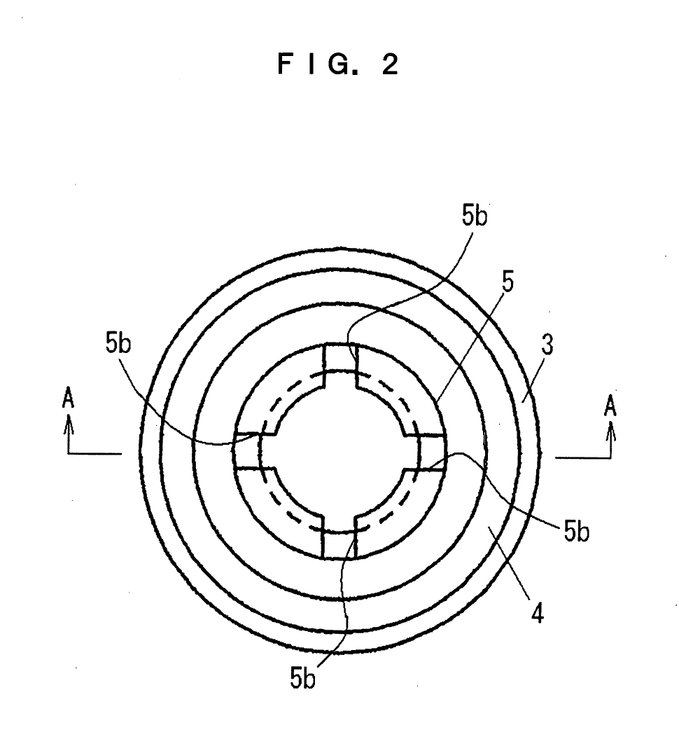

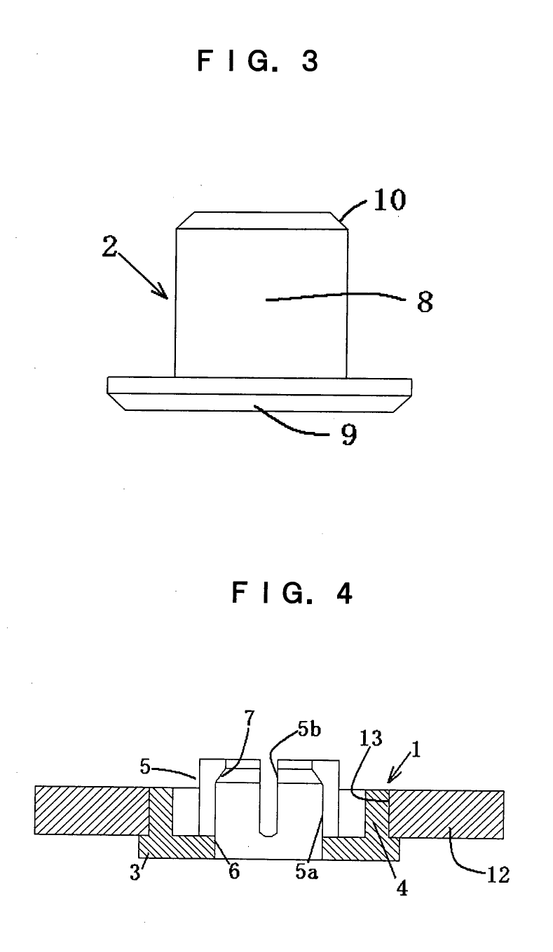

The mounting mechanism is composed of a supporting part 1 shown in FIG. 1 and FIG. 2 and a securing part 2 shown in FIG. 3. The supporting part 1 and the securing part 2 are both integrally formed with synthetic resin.

Said supporting part 1 is composed of an annular plate 3, a support cylinder 4 and a fixing cylinder 5. The support cylinder 4 projects concentrically with the axis line X-X along the longitudinal direction of a circular hole 6 of the annular plate 3 at one surface side (the upper side surface in the drawing) of the annular plate 3, wherein the fixing cylinder 5 has an inner circumferential surface 5a that is continuous to the circular center hole 6 at the one surface side of the annular plate 3 and that concurrently projects along the axis line X-X to be longer than the support cylinder 4. The fixing cylinder 5 has a tapered surface 7 whose diameter becomes smaller toward the end on the inner circumferential surface 5a in the vicinity of the end, and is divided into quarters along the circumferential direction by a notch 5b, which functions as a notch means, one end of which is open as shown in FIG. 2. With this configuration, excellent elastic deformation at the end of the fixing cylinder 5 can be obtained.

Furthermore, it is desirable that this division configuration be at least trisected or more.

The tapered surface 7 is formed on the inner circumferential surface 5a at the position, which is further extended compared to the end of the support cylinder 4 along the axis line X-X direction.

The securing part 2 shown in FIG. 3 is composed of a pressing portion 8 that penetrates through the circular center hole 6 and is inserted into the fixing cylinder 5 on the other surface (the lower surface side in the drawing) of the annular plate 3 and an end plate 9 arranged at the base of this pressing portion 8. The pressing portion 8 is cylindrical, and the end rim is a taper abrading rim 10. The external diameter dimension of the pressing portion 8 is set to be substantially the same or slightly larger (approximately 3/100 to 10/100 millimeters) compared to the internal diameter dimension of the circular center hole 6 of the annular plate 3 (see FIG. 1).

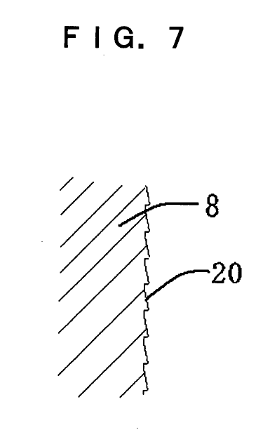

Next, procedures to assemble a rotary part 12 to a metal mounting plate 11 using the mounting mechanism as configured above will be described. FIG. 6 shows a state where the rotary part 12 is assembled to the mounting plate 11.

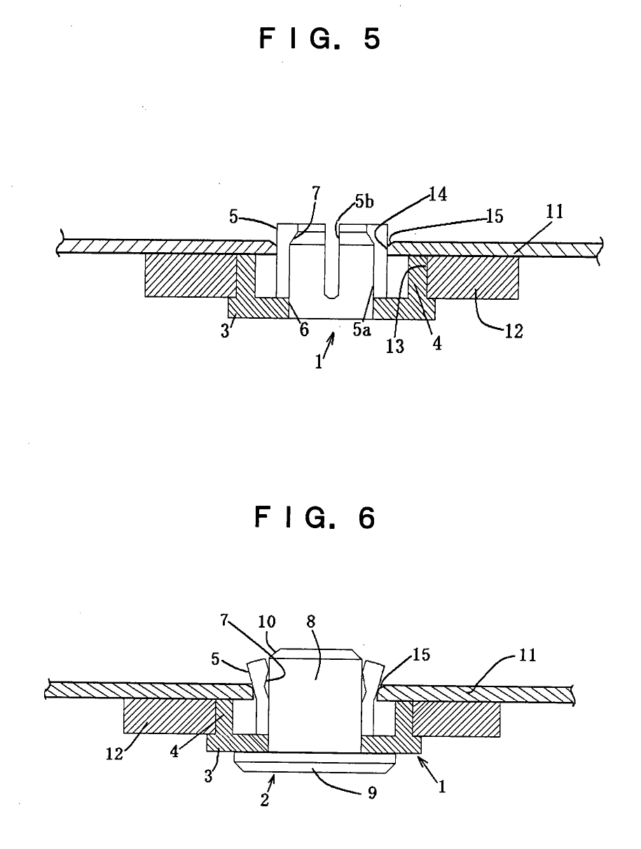

First, as shown in FIG. 4, the support cylinder 4 of the supporting part 1 is fitted into the circular hole 13 of the rotary part 12. Next, as shown in FIG. 5, the fixing cylinder 5 of the supporting part 1 is fitted into the circular fixing hole 14 of the mounting plate 11.

With this design, while movement of the rotary part 12 is prevented between the mounting plate 11 and the annular plate 3 of the supporting part 1, the rotary part 12 is rotatably maintained. The support cylinder 4 serves as a rotation bearing of the mounted rotary part 12.

Furthermore, in the circular fixing hole 14, the upper rim in FIG. 5 is chamfered. As shown in FIG. 6, when the end of the fixing cylinder 5 is warped outward radially by the pressing portion 8 of the securing part 2 associated with the elastic deformation, the circular fixing hole 14 of the mounting plate 11 is smoothly engaged with the chamfer 15, preventing undesirable damage of the fixing cylinder 5.

Further, the length from the end of the support cylinder 4 to the lower edge of the tapered surface 7 along the axis line X-X direction may be set at least at the length where the chamfer 15 portion is subtracted from the plate thickness of the mounting plate 11. Since elastic deformation at the end of the fixing cylinder 5 mainly occurs at the tapered surface 7, as shown in FIG. 6, elastic deformation occurs when the deformation passes the upper edge of the circular fixing hole 14 of the mounting plate 11, accomplishing securement without applying any excessive pressure to the circular fixing hole 14.

For the assembly, as shown in FIG. 6, the fixing cylinder 5 of the supporting part 1 is fitted into the circular fixing hole 14 of the mounting plate 11, then the pressing portion 8 of the securing part 2 is fitted into the fixing cylinder 5 and the abrading rim 10 of the pressing portion 8 comes into contact with the taper 7 of the fixing cylinder 5.

In addition, as shown in FIG. 6, if the securing part 2 is pushed until the end plate 9 comes into contact with the annular plate 3 of the supporting part 1, the tapered surface 7 is pressed by the abrading rim 10, and the end of the fixing cylinder 5 is warped outwardly due to its own elastic deformation, resulting in the expansion of the end of the fixing cylinder 5 outwardly compared to the circular fixing hole 14 of the mounting plate 11, solidly securing the supporting part 1 to the mounting plate 11. In the meantime, the rotary part 12 is mounted to the mounting plate 11 while maintaining the rotatable state.

The first embodiment of the present invention was described above. However, the present invention is not limited to this embodiment. In the embodiment, the edge of the circular fixing hole 14 of the mounting 11 is chamfered. However, the chamfer is not always necessary. Further, the mounting plate 11 may be made of a resin.

In addition, as in the modified example of the present invention shown in FIG. 7, the securing part 2 may have multiple serrated projections 20 that are inclined toward the end plate 9 side from the end side on the outer circumferential surface of the pressing portion 8.

With this design, since the projections 20 function to prevent detachment, the securing part 2 can be comparatively easily fitted into the fixing cylinder 5. However, it becomes difficult for the securing part 2 to be detached from the fixing cylinder 5 and the rotary 12 can be further solidly mounted to the mounting plate 11.

What is claimed is:

1. A rotary part mounting mechanism comprising a supporting part (1) that is fitted into a circular hole (13) established in the rotation center of a rotary part (12), and a securing part (2) that fixes the supporting part to a circular fixing hole (14) established in a mounting plate (11),
wherein said supporting part comprises an annular plate (3) having a circular center hole (6); a support cylinder (4) that projects concentrically with the axis line (X-X) of the circular center hole at one surface side of the annular plate, and projects along said axis line radially outward from the circular center hole, and that concurrently rotatably maintains the rotary part (12); and a fixing cylinder (5) that has an inner circumference surface, which is continuous to the circular center hole at the one surface side of the annular plate, and that concurrently projects along said axis line (X-X) to be longer than the support cylinder and fixes the mounting plate (11);
wherein said fixing cylinder contains a tapered surface (7) whose diameter becomes smaller toward the end of the fixing cylinder at a position that is further extending from the end along the axis line (X-X) direction of the support cylinder on said inner circumferential surface, said fixing cylinder being divided into three or more by a notch means along the circumference direction;
wherein said securing part is composed of a pressing portion (8) that passes through the circular center hole from the other surface side of the annular plate and is inserted into the fixing cylinder, and an end plate (9) arranged at the base of the pressing portion; and
wherein said support cylinder of the supporting part is fitted into the circular hole of the rotary part and said fixing cylinder of the supporting part is fitted into the circular fixing hole of the mounting plate so that said rotary part is rotatably held between said mounting plate and the annular plate of said supporting part; and the pressing portion of the securing part is fitted into the fixing cylinder and the tapered surface of the fixing cylinder is pressed by the end of said pressing portion and the end of the fixing cylinder is warped outward radially due to elastic deformation thereby to fix said mounting plate to said supporting part so as to prevent said mounting plate from being rotated.

2. The rotary part mounting mechanism according to claim 1, wherein said securing part (2) has multiple serrated projections (20) that are inclined toward the end plate (9) side from the end side on the outer circumferential surface of the pressing portion (8).
